(19) United States
(12) Patent Application Publication
(10) Pub. No.: US 2006/0190334 A1
(43) Pub. Date: Aug. 24, 2006

(54) Automated system and method for discounting medical bills of self-pay patients

(76) Inventor: Stephen E. Smith, Bartlett, IL (US)

Correspondence Address: Mark J. Young, Unit 202, 12086 Fort Caroline Road, Jacksonville, FL, 32225, US

(21) Appl. No.: 11/359,799

(22) Filed: Feb. 22, 2006

Related U.S. Application Data
(60) Provisional application No. 60/655,110, filed on Feb. 22, 2005.

(51) Int. Cl. G06Q 30/00; G06Q 10/00

(52) U.S. Cl. 705/14; 705/2

(57) ABSTRACT

A system and method for consistently, reliably and equitably discounting medical bills of self-pay patients includes a networked discounting engine operably coupled to a plurality of databases. The discounting engine is adapted to receive patient account data from one or more patient registration systems. Based upon the patient account data received, the discounting engine accesses the plurality of databases to determine financial, asset and demographic attributes for a patient or responsible party. Based upon the patient account data received, and the determined financial, asset and demographic variable values, the discounting engine determines weights and points. Weights and points are then combined by the discounting engine to determine a weighted discount percentage to be applied against the patient's outstanding account balance. The discounting engine then generates and sends to the patient registration system an output file containing the discount percentage and other patient information. This information along with other billing information is communicated to a patient accounting system for preparing a discounted bill.

### RELATED APPLICATION

This application claims the benefit of priority of U.S. Provisional Application 60/655,110, filed Feb. 22, 2005, the entire contents of which are incorporated herein.

### FIELD OF THE INVENTION

This invention relates generally to pricing, and more particularly, to an automated system and method for consistently and equitably discounting medical bills of self-pay patients.

Heading

### BACKGROUND

The number of uninsured individuals who do not qualify for government programs such as Medicare or Medicaid is growing. Concomitantly, medical costs continue to soar. The result is a surge in the number of patients who are unable to pay their medical bills. To fend off aggressive bill collection tactics, these patients often resort to bankruptcy.

A related problem is the disparity between what individuals pay versus what insurance companies and government programs pay for the same service. Insurers use their buying power and government programs use their legal authority to secure deep discounts. In sharp contrast, prices for private-pay patients are invariably higher, often several times higher, because they lack negotiating power.

This long-standing hospital industry pricing practice—along with some hospitals' aggressive bill-collection tactics—has caught the attention of lawmakers. Confronted with heightened scrutiny and unfavorable publicity, many hospital administrators expressed reluctance to provide charity care or discounts to uninsured patients for fear of violating a Federal Anti-Kickback Statute. In response, the Office of Inspector General (“OIG”) for the U.S. Department of Health and Human Services issued an alert on Feb. 2, 2004, which explained that as long as discounts are not tied directly or indirectly to the furnishing of items or services reimbursed or paid by a Federal healthcare program, the Federal Anti-Kickback Statute does not prohibit discounts to uninsured patients who are unable to pay their bills.

The OIG's Alert allayed some of the concerns which contributed to hospitals' reluctance to provide discounts to uninsured patients. Subsequently, some hospitals began offering discounts to uninsured patients. However, the discounts have been rather limited, and offered on an ad hoc basis, without regard to need and ability to pay.

A system and method for consistently, reliably and equitably discounting medical bills of self-pay patients is needed. The invention is directed to fulfilling one or more of the needs and overcoming one or more of the problems as set forth above.

### SUMMARY OF THE INVENTION

To overcome problems as set forth above, a system and method for consistently, reliably and equitably discounting medical bills of self-pay patients are provided. The system and method includes a networked discounting engine (i.e., discounting hardware and/or software) operably coupled to a plurality of databases. The discounting engine is adapted to receive patient account data from one or more patient registration systems. Based upon the patient account data received, the discounting engine accesses the plurality of databases to determine financial, asset and demographic attributes for a patient or responsible party. Based upon the patient account data received, and the determined financial, asset and demographic variable values, the discounting engine determines weights and points. Weights and points are then combined by the discounting engine to determine a weighted discount percentage to be applied against the patient's outstanding account balance. The discounting engine then generates and sends to the patient registration system an output file containing the discount percentage and other patient information. This information along with other billing information is communicated to a patient accounting system for preparing a discounted bill.

The term “hospital” is used herein for reference convenience and is intended to encompass all types of healthcare providers.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram of a work flow for an exemplary system for equitably discounting medical bills of self-pay patients at the time of patient registration, according to principles of the invention; and

FIG. 2 is a high level block diagram of a work flow for an exemplary system for equitably discounting medical bills of self-pay patients after patient discharge but prior to billing, according to principles of the invention; and

FIG. 3 is a high level block diagram of a work flow for an exemplary system for equitably discounting medical bills of self-pay patients following patient discharge and initial billing, according to principles of the invention; and

FIG. 4 is a table of input variables used by an exemplary system and method for equitably discounting medical bills of self-pay patients following patient discharge and initial billing, according to principles of the invention; and

FIG. 5 is a first table of output variables produced by an exemplary system and method for equitably discounting medical bills of self-pay patients following patient discharge and initial billing, according to principles of the invention; and

FIG. 6 is a second table of output variables produced by an exemplary system and method for equitably discounting medical bills of self-pay patients following patient discharge and initial billing, according to principles of the invention.

Those skilled in the art will appreciate that the invention is not limited to the exemplary embodiments depicted in the figures or the shapes, relative sizes, proportions or materials shown in the figures.

### DETAILED DESCRIPTION

In an exemplary implementation of the invention, a system and method for consistently, reliably and equitably discounting medical bills of self-pay patients is provided. An exemplary system generally includes a networked discounting engine operably coupled to a plurality of databases. The discounting engine is adapted to receive patient account data from one or more patient registration systems. Based upon the patient account data received, the discounting engine accesses the plurality of databases to determine financial, asset and demographic variable values for a patient. Based upon the patient account data received, and the determined financial, asset and demographic variable values, the discounting engine determines weights and points. Weights and points are then combined by the discounting engine to determine a discount percentage to be applied against the patient's outstanding account balance. The discounting engine then generates and sends to the patient registration system an output file containing the discount percentage and other patient information. This information along with other billing information is communicated to a patient accounting system for preparing a discounted bill.

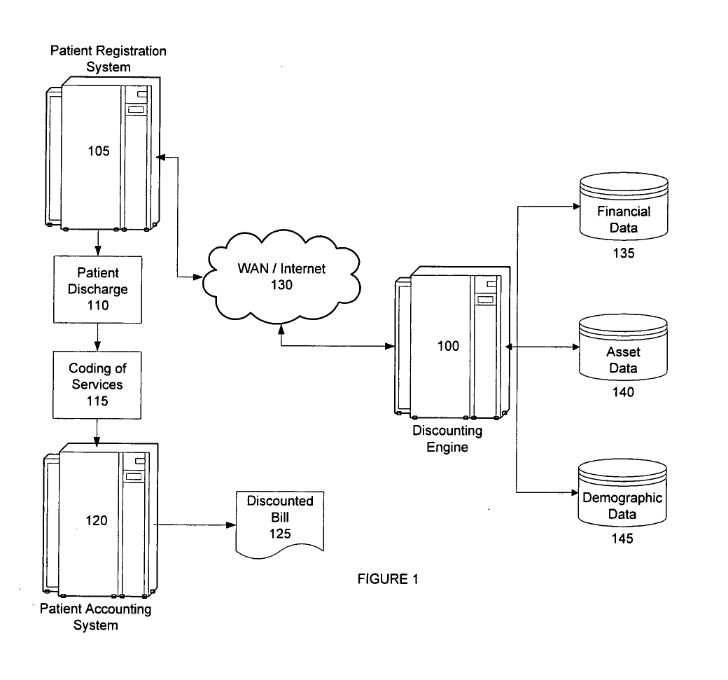

Referring to FIGS. 1, 2 and 3, exemplary systems for consistently, reliably and equitably discounting medical bills of self-pay patients according to principles of the invention includes an exemplary discounting engine 100 comprised of a computer system. The computer system of the exemplary discounting engine 100, has a bus for communicating information, a central processing unit (CPU), a read only memory (ROM), a random access memory (RAM), a mass storage device, and communications equipment. The storage device may include a hard disk, CD-ROM and/or DVD drive, tape drive, memory (e.g., RAM, ROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as operating system software is stored on and executable on the computer system. These elements are typically included in many computers and the aforementioned computer system of the discounting engine 100 is intended to represent a broad category of computer systems capable of functioning as a computer, receiving input data, sending output data and communicating with a plurality of databases in accordance with principles of the invention. Of course, the computer system of the discounting engine 100 may include fewer, different and/or additional elements, functioning as a single computer or as a distributed system, provided it is capable of performing the aforementioned functions in accordance with the principles of the invention.

The computer system of the discounting engine 100 also includes information, documents and software needed to provide functionally and enable performance of methodologies in accordance with an exemplary embodiment of the invention. For example, the computer system of the discounting engine 100 may include a discounting program comprised of software to enable performance of the aforementioned functions in accordance with the principles of the invention.

The discounting engine obtains data from a plurality of data sources, such as the financial, asset and demographic databases depicted in FIGS. 1, 2 and 3. Each of the plurality of databases 135, 140 and 145 may be an integral part of, or external to, the discounting engine 100. External databases may be either local or remote and communicatively coupled to the discounting engine 100. Additionally, the plurality of databases 135, 140 and 145 may include fewer, different and/or additional data sources, combined in a single database or distributed among a plurality of data sources, provided it is configured to supply the financial, asset and demographic data required by the discounting engine 100 according to principles of the invention.

The discounting engine 100 is adapted to receive patient account data from one or more patient registration systems 105 and/or patient accounting systems 120. In an exemplary implementation, the patient registration system 105 and patient accounting system 120 is comprised of one or more hospital computer systems adapted to create, store and communicate patient accounts, and/or to produce bills for medical services provided to a patient. The computer system of the exemplary patient registration system 105 and patient accounting system 120, may have a bus for communicating information, a central processing unit (CPU), a read only memory (ROM), a random access memory (RAM), a mass storage device, and communications equipment. The storage device may include a hard disk, CD-ROM and/or DVD drive, tape drive, memory (e.g., RAM, ROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as operating system software is stored on and executable on the computer systems. These elements are typically included in many computers and the aforementioned computer systems of the patient registration system 105 and patient accounting system 120 are intended to represent a broad category of computer systems capable of functioning as a computer, receiving input data, sending output data and communicating with a plurality of databases in accordance with principles of the invention. Of course, the computer systems of the patient registration system 105 and patient accounting system 120 may include fewer, different and/or additional elements, functioning as a single computer or as a distributed system, provided they are capable of performing the aforementioned functions in accordance with the principles of the invention. Furthermore, although only one patient registration system 105 and one patient accounting system 120 is shown in the Figures, those skilled in the art will appreciate that any number of patient registration and accounting systems associated with any number of hospitals may be utilized in accordance with the principles of the invention.

Each of the aforementioned computer systems 100, 105, 120 may be directly or indirectly communicatively connected to one or more networks, such as a global computer network (e.g., the Internet), a wide area network (WAN), a local are network (LAN),or any other network that facilitates communications between the aforementioned computer systems 100, 105, 120, or some combination of the foregoing. Likewise, each data source 135, 140 and 145 that is not local to the discounting engine 100 may reside on computer systems that are directly or indirectly communicatively connected to one or more networks, such as a global computer network (e.g., the Internet), a wide area network (WAN), a local are network (LAN),or any other network that facilitates communications between the aforementioned data source 135, 140 and 145, and the discounting engine 100.

One or more file servers, such as ftp server 215, may be provided to communicate files/data, such as via the File Transfer Protocol, between the patient systems (e.g., patient accounting system and/or patient registration system) and the discounting engine. Via this communication channel, data may be transferred for discounting as in 205 and a discount may be returned as in 210.

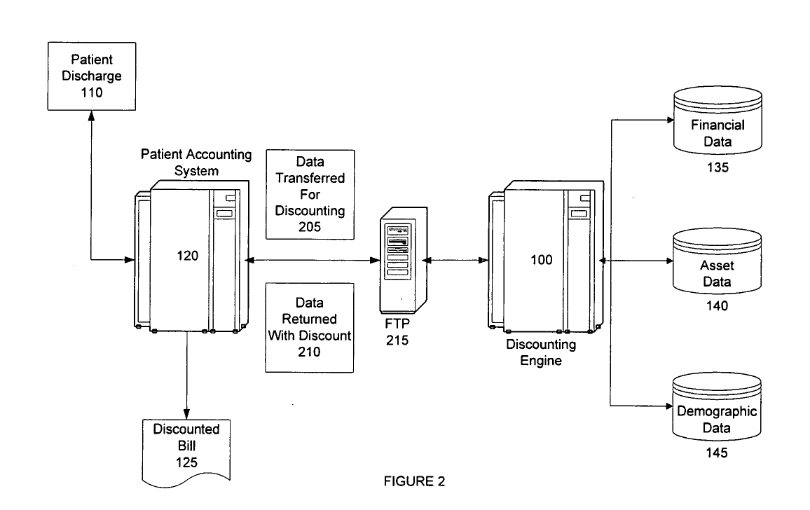

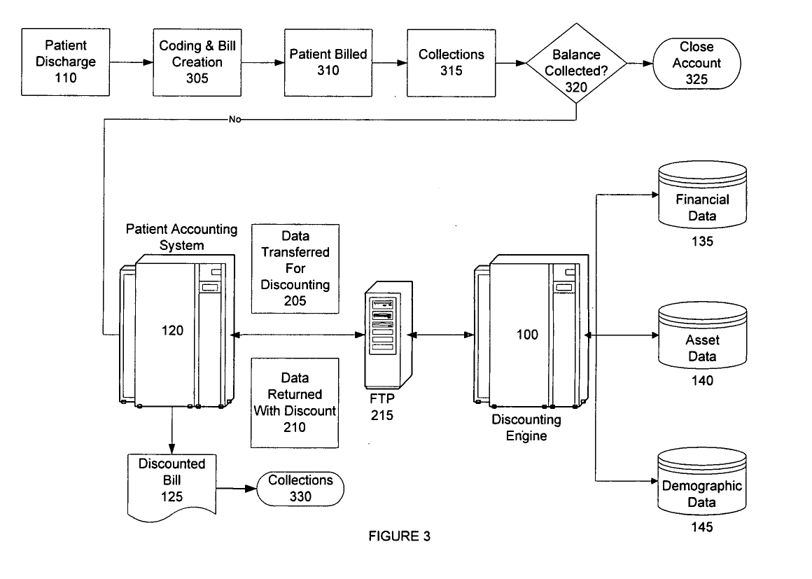

Referring again to FIGS. 1, 2 and 3, overviews of an exemplary work flows for an exemplary implementations of systems for equitably discounting medical bills of self-pay patients, according to principles of the invention, is provided. The work flow of FIG. 1 illustrates implementation upon patient registration, but before discharge 110, coding 115 and billing 125. Thus, the initial bill 125 will be discounted in this implementation. The work flow of FIG. 2 illustrates implementation upon patient discharge 110 but before billing 125. Again, the initial bill 125 will be discounted in this implementation. The work flow of FIG. 3 illustrates implementation after patient discharge 110, coding and initial billing 305, 310. Thus, the bill may be discounted to facilitate collections 315, if initial collections efforts fail 320 in this implementation. Otherwise, in this implementation, the entire balance is collected 320 and the account may be closed 325. If a discounted balance remains, an unpaid portion of a discounted bill may, of course, be referred to collections 330.

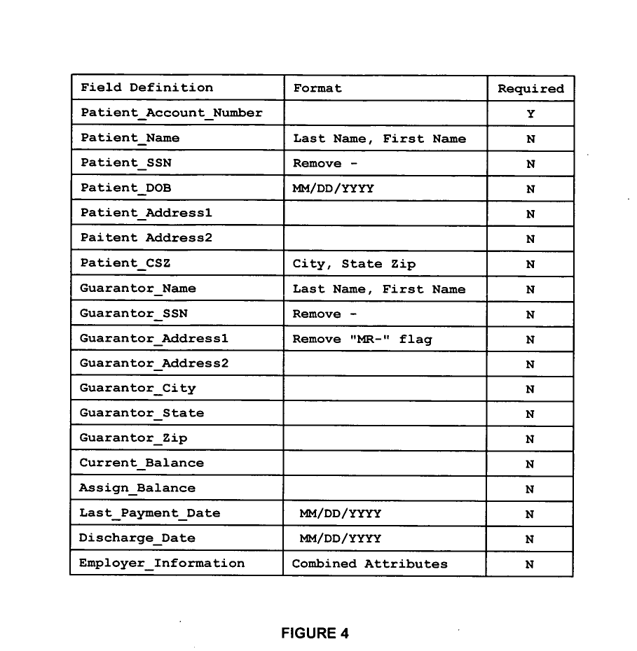

A patient account is created in a patient registration system 105 when a patient is admitted into a hospital. In a preferred embodiment, the patient account includes the data identified in the table of input data provided as FIG. 4. In general, the information includes identifying information, such as name, address, date of birth, social security number, etc. . . . If the patient is a minor or incapacitated, identifying information for a guarantor, such as a parent or guardian, may also be provided. Additionally, information about the balance, last payment and discharge date are provided. The patient account data may be communicated to the discounting engine via the patient registration system 105 and/or another system, such as the patient accounting system 120. Using the account data and data obtained from the various data sources 135, 140 and 145, the discounting engine computes a discount percentage.

In a preferred implementation, a discount percentage between 0 and 100% is computed as a sum total of discount points divided by a sum total of weights. Because weights are in the denominator, they are inversely proportional to the discount percentage. Because discount points are in the numerator, they are proportional to the discount percentage. An algorithm utilized to assign weights and discount points to each attribute is based upon the overall probability of repayment predictiveness of each variable. Thus, a higher discount is attained by assigning a low weight and/or a high discount point value to an attribute. In an exemplary embodiment, weights may vary from 0 to approximately 2.0 and discount points may vary from 0 to approximately 100.0 per attribute. Those skilled in the art will readily appreciate that other ranges of values and other methods of weighting may be utilized within the scope of the invention.

In a preferred implementation, weights and discount points are assigned to various attributes, such as the following:
Age—The higher the Age, the higher the discount
Current Balance—The higher the Current Balance, the higher the discount
Work—If unemployed, higher discount
Credit Score—The lower the Credit Score the higher the discount
Deceased—If deceased, higher discount
Chapter 7 Bankruptcy—If in Chapter 7 Bankruptcy, higher discount
Chapter 13 Bankruptcy—If in Chapter 13 Bankruptcy, higher discount
Number of Collection Tradelines—The higher the Number of Collection Tradelines, the higher the discount
Sum of Available Credit—The lower the Sum of Available Credit, the higher the discount
Income Estimation—The lower the Income Estimation, the higher the discount
Median Home Value—The lower the Median Home Value, the higher the discount
Mortgage Balance—The higher the Mortgage Balance, the lower the discount
Sum of Monthly Payments On Open Trades—The higher the Sum of Monthly Payments On Open Trades, the higher the discount
# of Credit Accts Opened In Past 6 Mos.—The higher the # of Credit Accts Opened In Past 6 Mos., the lower the discount
# of Derogatory Trades—The higher the # of Derogatory Trades, the higher the discount

Each of the foregoing attributes may be obtained from one or more data sources based upon the account data. In combination, they provide a sound basis for predicting an overall probability of repayment. Concomitantly, the attributes may be ascertained from one or commercially available and/or publicly accessible databases, based upon the supplied account information. By way of illustration and not limitation, the data sources may include credit bureau databases, bankruptcy databases, Postal Service databases, deceased databases, Social Security Administration databases, Census Bureau databases, other demographic databases, and income estimation databases, comprising the financial, asset and demographic databases 135, 140 and 145 shown in FIGS. 1, 2 and 3. Those skilled in the art will appreciate that other data sources may be utilized in lieu of and/or in addition to any of the foregoing data sources. Additionally, it will be readily apparent that the invention is not limited to the databases, or to the number of databases, conceptually illustrated in FIGS. 1, 2 and 3.

Advantageously, the system and method for consistently and equitably discounting medical bills of self-pay patients in accordance with the principles of the invention provides an automated system that computes individual patient-unique discount percentages in order to address the growing number of uncollected, self pay patient accounts. This introduces and applies risk-based analysis to the healthcare receivables industry. Another advantage is that the system and method of the invention takes into account a broad array of available credit data attributes, demographic variables, asset searches and income estimations to make weighted point assignments and compute a unique temporal patient-specific discount percentage based on the patient's financial means and perceived ability to re-pay the debt. The computation of the self pay patient discount percentage is made at the account level at the time of patient registration, billing or collection. Thus, it provides a patient-specific discount percentage based on the patient's financial means and perceived ability to re-pay the debt at the relevant time. Accordingly, if the patient's circumstances change over time, a newly computed discount may differ from a previous discount to equitably account for the changed circumstances. Most importantly, the invention helps resolve the inequity of treatment towards uninsured patients, which is not experienced by patients with insurance or those receiving government assistance.

The system and method for consistently and equitably discounting medical bills of self-pay patients in accordance with the principles of the invention may operate in real-time, on-demand, batch or other modes. The system may be adapted to process large batch files of accounts simultaneously. In lieu of or in addition to batch processing, the system may be configured to process individual requests and provide a live, real-time discounting answer.

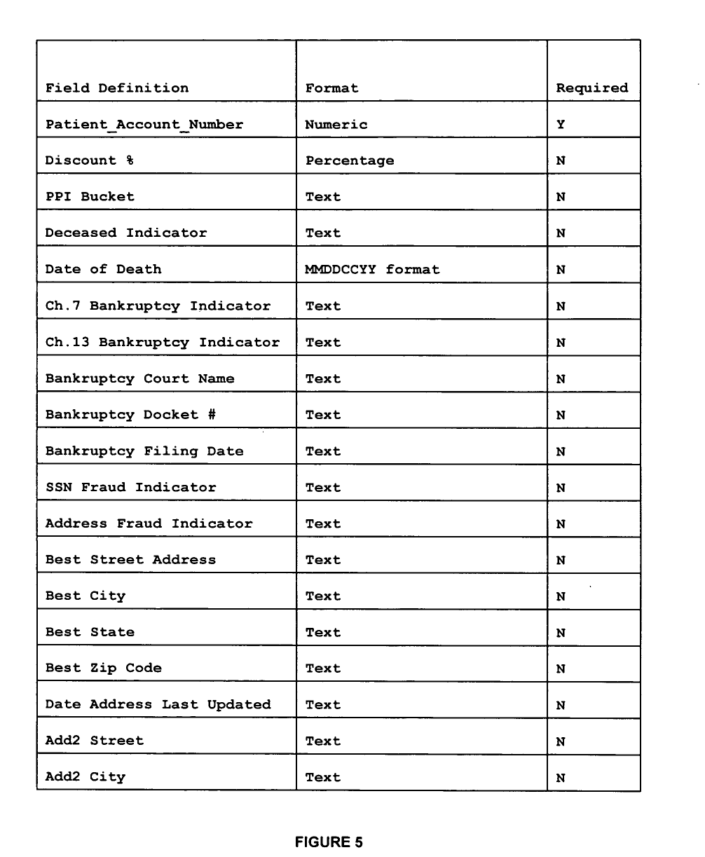

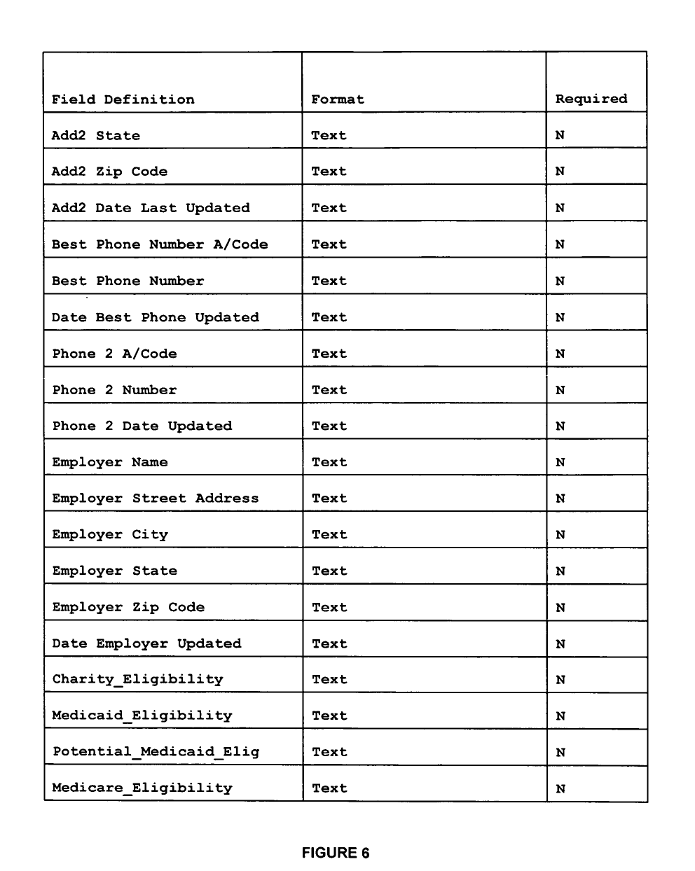

Upon calculating a discount percentage, an output file containing a patient identification number, the original balance, the recommended discount percentage and the newly computed patient balance is communicated back to the patient accounting and/or registration systems. The data for an exemplary output file is shown in FIGS. 5 and 6. If a balance has not been accrued at the time a discount is computed, such as if the discount is computed before medical services are actually rendered, the balances may be null values. In such a case, the discount percentage may be applied to any balance accrued thereafter.

To protect the privacy of sensitive medical data, all electronic communications may be conducted over using cryptographic protocols which provide secure communications on networks and the Internet, such as Secure Sockets Layer (SSL) and Transport Layer Security (TLS) protocols. Additionally, the data may be packaged in an encrypted file prior to communication. Any and all security measures that are now known or hereafter developed and suitable for protecting sensitive patient information communicated via network may be applied with the present invention.

In another embodiment of the invention, a Charity Flag Recommendation and/or a Medicaid Flag Recommendation may be included in the output file. Thus, if a patient may qualify for charity treatment according to established hospital guidelines, or if a patient may qualify for government assistance, the hospital is notified. These qualifications can determined from the input data and attribute data determined from the databases 135, 140 and 145.

In an exemplary operation, an agency may contract with a healthcare provider or their affiliates to act as their agent, with permissible purpose in securing credit and financial information regarding their patients. A file or batch of self pay patient accounts may be sent to the agency, inclusive of a patient identification number, date of birth of the patient, name of responsible party, address of responsible party, social security number of responsible party, balance owed and date the service was provided. The agency's system in accordance with the invention simultaneously requests the external data variables for each account and applies the file of accounts up against the demographic databases and income estimation databases. Upon retrieval of the requested data variables, a file complete with all of the retrieved attributes may systematically be loaded into the modeling engine. A resulting output file is encrypted and returned to the healthcare provider so that a new invoice complete with the post-discounted balance can be generated and sent to each patient.

In one mode for practicing the invention, i.e., batch mode, the healthcare provider (e.g., hospital) bundles a batch of accounts at similar life cycles and sends them in the same encrypted file to the agency to be processed through the discounting engine and returned in the same batch file format. There are specific volume and automation advantages when discounting large quantities of accounts at the same time. In a batch mode, the healthcare provider can request the agency to provide discount percentages prior to generating the initial bill to the patient, following the unsuccessful attempt to collect the original bill, or at a point of outsourced collection assistance.

Another mode for practicing the invention is real-time Processing whereby the registrar at the healthcare provider submits a discounting request from the patient registration system of the hospital (at the point of patient registration or pre-registration) via network (e.g., the Internet) to the agency's system, and receives a real time discount percentage answer at the individual patient account level. There is an inherent communication and technological ease in using the invention to provide a real time processing solution.

While an exemplary embodiment of the invention has been described in detail, it should be apparent that modifications and variations thereto are possible, all of which fall within the true spirit and scope of the invention. With respect to the above description then, it is to be realized that the optimum relationships for the components of the invention and steps of the process, to include variations in form, function and manner of operation, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention.

What is claimed is:

1. A system for discounting medical bills of self-pay patients, said system comprising, a discounting engine adapted to receive patient account data for each self-pay patient, and obtain attribute data corresponding to said patient account data, said discounting engine being further adapted to compute a discount for each self-pay patient based upon the account data and attribute data corresponding to each self-pay patient, said attribute: data including one or more credit data.

2. A system for discounting medical bills of self-pay patients according to claim 1, wherein said attribute data further includes one or more asset data.

3. A system for discounting medical bills of self-pay patients according to claim 1, wherein said attribute data further includes one or more demographic data.

4. A system for discounting medical bills of self-pay patients according to claim 1, wherein said attribute data includes one or more attribute values from the group consisting of Age, Current Balance, Work, Credit Score, Deceased, Chapter 7 Bankruptcy, Chapter 13 Bankruptcy, Number of Collection Tradelines, Sum of Available Credit, Income Estimation, Median Home Value, Mortgage Balance, Sum of Monthly Payments On Open Trades, Number of Credit Accounts Opened In Past 6 Months, and Number of Derogatory Trades.

5. A system for discounting medical bills of self-pay patients according to claim 1, wherein said attribute data includes values for Age, Current Balance, Work, Credit Score, Deceased, Chapter 7 Bankruptcy, Chapter 13 Bankruptcy, Number of Collection Tradelines, Sum of Available Credit, Income Estimation, Median Home Value, Mortgage Balance, Sum of Monthly Payments On Open Trades, Number of Credit Accounts Opened In Past 6 Months, and Number of Derogatory Trades.

6. A system for discounting medical bills of self-pay patients according to claim 1, wherein said discounting engine is further adapted to assign a discount point value to each of the attribute data.

7. A system for discounting medical bills of self-pay patients according to claim 1, wherein said discounting engine is further adapted to assign a numerical weight value to each of the attribute data.

8. A system for discounting medical bills of self-pay patients according to claim 1, wherein said discounting engine is further adapted to assign a discount point value and a numerical weight value to each of the attribute data.

9. A system for discounting medical bills of self-pay patients according to claim 1, wherein said discounting engine is further adapted to assign a discount point value and a numerical weight value to each of the attribute data and said computed discount equals the sum of all discount point values divided by the sum of all numerical weight values.

10. A system for discounting medical bills of self-pay patients, said system comprising, a discounting engine adapted to receive patient account data for each self-pay patient, and obtain attribute data corresponding to said patient account data, said discounting engine being further adapted to compute a discount for each self-pay patient based upon the account data and attribute data corresponding to each self-pay patient, said attribute data including one or more credit data, one or more asset data and one or more demographic data, and said attribute data includes one or more attribute values from the group consisting of Age, Current Balance, Work, Credit Score, Deceased, Chapter 7 Bankruptcy, Chapter 13 Bankruptcy, Number of Collection Tradelines, Sum of Available Credit, Income Estimation, Median Home Value, Mortgage Balance, Sum of Monthly Payments On Open Trades, Number of Credit Accounts Opened In Past 6 Months, and Number of Derogatory Trades.

11. A system for discounting medical bills of self-pay patients according to claim 10, wherein said attribute data includes values for Age, Current Balance, Work, Credit Score, Deceased, Chapter 7 Bankruptcy, Chapter 13 Bankruptcy, Number of Collection Tradelines, Sum of Available Credit, Income Estimation, Median Home Value, Mortgage Balance, Sum of Monthly Payments On Open Trades, Number of Credit Accounts Opened In Past 6 Months, and Number of Derogatory Trades.

12. A system for discounting medical bills of self-pay patients according to claim 10, wherein said discounting engine is further adapted to assign a discount point value to each of the attribute data.

13. A system for discounting medical bills of self-pay patients according to claim 10, wherein said discounting engine is further adapted to assign a numerical weight value to each of the attribute data.

14. A system for discounting medical bills of self-pay patients according to claim 10, wherein said discounting engine is further adapted to assign a discount point value and a numerical weight value to each of the attribute data.

15. A system for discounting medical bills of self-pay patients according to claim 14, wherein said discounting engine is further adapted to assign a discount point value and a numerical weight value to each of the attribute data and said computed discount equals the sum of all discount point values divided by the sum of all numerical weight values.

16. A method for discounting medical bills of self-pay patients, said method comprising, receiving patient account data for each self-pay patient, obtaining attribute data corresponding to said patient account data, and computing a discount for each self-pay patient based upon the account data and attribute data corresponding to each self-pay patient, said attribute data including one or more credit data, one or more asset data and one or more demographic data, and said attribute data includes one or more attribute values from the group consisting of Age, Current Balance, Work, Credit Score, Deceased, Chapter 7 Bankruptcy, Chapter 13 Bankruptcy, Number of Collection Tradelines, Sum of Available Credit, Income Estimation, Median Home Value, Mortgage Balance, Sum of Monthly Payments On Open Trades, Number of Credit Accounts Opened In Past 6 Months, and Number of Derogatory Trades.

17. A method for discounting medical bills of self-pay patients according to claim 16, wherein said attribute data includes values for Age, Current Balance, Work, Credit Score, Deceased, Chapter 7 Bankruptcy, Chapter 13 Bankruptcy, Number of Collection Tradelines, Sum of Available Credit, Income Estimation, Median Home Value, Mortgage Balance, Sum of Monthly Payments On Open Trades, Number of Credit Accounts Opened In Past 6 Months, and Number of Derogatory Trades.

18. A method for discounting medical bills of self-pay patients according to claim 16, wherein the step of computing a discount for each self-pay patient based upon the account data and attribute data corresponding to each self-pay patient further includes assigning a discount point value to each of the attribute data.

19. A method for discounting medical bills of self-pay patients according to claim 16, wherein the step of computing a discount for each self-pay patient based upon the account data and attribute data corresponding to each self-pay patient further includes assigning a numerical weight value to each of the attribute data.

20. A method for discounting medical bills of self-pay patients according to claim 16, wherein the step of computing a discount for each self-pay patient based upon the account data and attribute data corresponding to each self-pay patient further includes assigning a discount point value and a numerical weight value to each of the attribute data and said computing a discount by calculating the sum of all discount point values and dividing said sum of all discount point values by the sum of all numerical weight values.
